(19) United States
(12) Patent Application Publication
(10) Pub. No.: US 2014/0023821 A1
(43) Pub. Date: Jan. 23, 2014

(54) MAGNETIC COMPOSITE AND METHOD OF MANUFACTURING THE SAME, AND ARTICLE AND DEVICE INCLUDING THE SAME

(71) Applicant: SAMSUNG ELECTRONICS CO., LTD., Suwon-si (KR)

(72) Inventors: Soon-Jae KWON, Yongin-si (KR); In-Gyu KIM, Gwanmyeong-si (KR); Eun-Sung LEE, Hwaseong-si (KR); Se-Yun KIM, Seoul (KR)

(73) Assignee: SAMSUNG ELECTRONICS CO., LTD., Suwon-si (KR)

(21) Appl. No.: 13/736,430

(22) Filed: Jan. 8, 2013

(30) Foreign Application Priority Data
Jul. 23, 2012 (KR) 10-2012-0080143

(51) Int. Cl. H01F 1/01

(52) U.S. Cl. CPC H01F 1/012
USPC 428/116; 428/402; 428/156; 252/62.55

(57) ABSTRACT

A magnetic composite including a magnetic material; and a binder including a metallic glass, a glass frit, or a combination thereof.

This application claims priority to and the benefit of Korean Patent Application No. 10-2012-0080143, filed on Jul. 23, 2012, and all the benefits accruing therefrom under 35 U.S.C. §119, the content of which is incorporated herein in its entirety by reference.

### BACKGROUND

1. Field

Disclosed is a magnetic composite and a method of manufacturing the same, and an article and a device including the magnetic composite.

2. Description of the Related Art

A cooling system, such as a refrigerator or a freezer, decreases a temperature by repeating a compression-condensation-expansion-evaporation cooling cycle. Specifically, the cooling cycle is implemented by increasing the temperature and pressure of a coolant from a low temperature and a low pressure to a high temperature and a high pressure, condensing the coolant at the high temperature and the high pressure under external air, reducing the pressure of the condensed coolant, and evaporating the coolant under a low pressure to absorb the heat therefrom. However, this type of cooling system uses a coolant that causes severe global warming effects and is environmentally limited.

Accordingly, there is an unmet need for an environmentally friendly cooling system which would not use an environmentally undesirable coolant, and thus would be environmentally friendly, and would be highly efficient. Towards this goal, a magnetic cooling system using a magnetic material and a permanent magnet has been considered.

Magnetic cooling is based on the magnetocaloric effect, wherein a magnetic material has a spin arrangement that is changed depending on a magnetic field causing the system to be heated or cooled. A magnetic cooling system may be environmentally-friendly, may provide reduced noise, and may have high efficiency. This magnetic cooling system includes a magnetocaloric magnetic material and a heat exchange medium for transferring heat. However, it is desired that such magnetic cooling systems provide improved cooling performance, and it would be desirable to have a material having improved mechanical and physical properties to provide improved heat exchange efficiency.

### SUMMARY

An embodiment provides a magnetic composite which is capable of providing improved mechanical and physical properties and improved processablility.

Another embodiment provides a method of manufacturing the magnetic composite.

Yet another embodiment provides an article including the magnetic composite.

Still another embodiment provides a device including the article.

According to an embodiment, a magnetic composite including a magnetic material; and a binder including a metallic glass, a glass frit, or a combination thereof is provided.

The magnetic material may include a magnetocaloric material, a soft magnetic material, a hard magnetic material, or a combination thereof.

The magnetic material may include a metal, a semi-metal, an alloy thereof, an oxide thereof, or a combination thereof.

The magnetic material may include iron (Fe), manganese (Mn), cobalt (Co), nickel (Ni), niobium (Nb), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), boron (B), silicon (Si), germanium (Ge), gallium (Ga), arsenic (As), antimony (Sb), tellurium (Te), phosphorus (P), arsenic (As), antimony (Sb), bismuth (Bi), an alloy thereof, an oxide thereof, a nitride thereof, or a combination thereof.

The magnetic material may be in the form of a particle.

The magnetic material may have a particle diameter of about 1 nanometer (nm) to about 100 micrometers (μm).

The binder may have a glass transition temperature (Tg) of about 50° C. to about 800° C.

The binder may have a supercooled liquid region of about 1 Kelvin (K) to about 200 K.

The metallic glass may be an alloy including copper (Cu), titanium (Ti), nickel (Ni), zirconium (Zr), iron (Fe), magnesium (Mg), calcium (Ca), cobalt (Co), palladium (Pd), platinum (Pt), gold (Au), cerium (Ce), lanthanum (La), yttrium (Y), gadolinium (Gd), beryllium (Be), tantalum (Ta), gallium (Ga), aluminum (Al), hafnium (Hf), niobium (Nb), strontium (Sr), ytterbium (Yb), lead (Pb), platinum (Pt), silver (Ag), phosphorus (P), boron (B), silicon (Si), carbon (C), tin (Sn), zinc (Zn), lithium (Li), molybdenum (Mo), tungsten (W), manganese (Mn), erbium (Er), chromium (Cr), praseodymium (Pr), thulium (Tm), or a combination thereof.

The binder may encapsulate at least a portion of the magnetic material.

The binder may be included in an amount of about 0.01 weight percent (wt %) to about 50 wt %, based on a total weight of the magnetic composite.

The magnetic material may include two or more materials, each having a different Curie temperature.

According to another embodiment, a method of manufacturing a magnetic composite includes: contacting a magnetic material with a binder including a metallic glass, a glass frit, or a combination thereof to form a mixture; and heat-treating the mixture at a temperature greater than or equal to a glass transition temperature of the binder to manufacture the magnetic composite.

The heat-treating of the mixture may be at a temperature which is lower than a melting temperature of the magnetic material.

The heat-treating of the mixture may be performed at about 50° C. to about 800° C.

The method may further include shaping the mixture, and the shaping may include hot press formation, hot extrusion formation, hot rolling formation, spark plasma sintering, or a combination thereof.

According to yet another embodiment, an article including the magnetic composite is provided.

The article may have a spherical shape, a plate shape, a microchannel structure, a micro-fin structure, a honey-comb structure, or a combination thereof.

According to still another embodiment, a device including the article is provided.

The device may be a magnetic cooling device, a magnetocaloric generator, or a magnetocaloric pump.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1 is a schematic view showing an embodiment of a magnetic composite;

FIG. 2 is a schematic view showing another embodiment of a magnetic composite;

FIGS. 3A to 3F are schematic views showing various shapes of an embodiment of an article including an embodiment of the magnetic composite;

FIG. 4 is a scanning electron microscope (SEM) photograph showing the cross-section of the magnetic composite according to Example 1;

FIG. 5A is a graph of magnetic entropy change (ΔS, Joules per kilogram per Kelvin, J/kg·K) versus temperature (Kelvin, K) of the magnetic material according to Comparative Example 1;

FIG. 5B is a graph of magnetic entropy change (ΔS, Joules per kilogram per Kelvin, J/kg·K) versus temperature (Kelvin, K) of the magnetic composite according to Example 1;

FIG. 6A is a graph of magnetic entropy change (ΔS, Joules per kilogram per Kelvin, J/kg·K) versus temperature (Kelvin, K) of the magnetic material according to Comparative Example 2; and

FIG. 6B is a graph of magnetic entropy change (Joules per kilogram per Kelvin, J/kg·K) versus temperature (Kelvin, K) of the magnetic composite according to Example 2.

### DETAILED DESCRIPTION

Exemplary embodiments will hereinafter be described in further detail with reference to the accompanying drawings, in which various embodiments are shown. This disclosure may, however, be embodied in many different forms and should not be construed as limited to the exemplary embodiments set forth herein. Accordingly, the embodiments are merely described below, by referring to the figures, to explain aspects of the present description. These embodiments are provided so that this disclosure will be thorough and complete, and will fully convey the scope of the claims to those skilled in the art.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting. As used herein, the singular forms “a,” “an” and “the” are intended to include the plural forms as well, unless the context clearly indicates otherwise. The term “or” means “and/or.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, a magnetic composite according to an embodiment is further disclosed referring to the drawings.

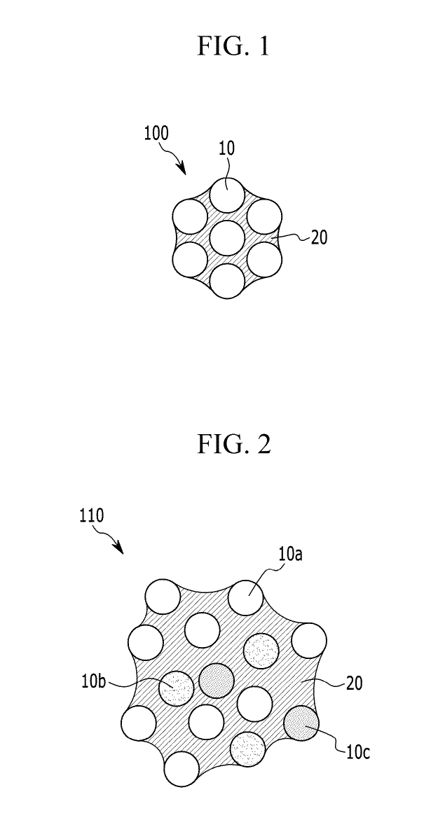

FIG. 1 is a schematic view showing an embodiment of a magnetic composite.

Referring to FIG. 1, the magnetic composite 100 according to an embodiment includes a magnetic material 10, and a binder 20 including a metallic glass, a glass frit, or a combination thereof.

The magnetic material 10 is not limited to a particular material as long as it becomes magnetic when exposed to a magnetic field, and for example, may include a magnetocaloric material, a soft magnetic material, a hard magnetic material, or a combination thereof.

The magnetic material 10 may include a metal, a semi-metal, an alloy thereof, an oxide thereof, or a combination thereof. In an embodiment, for example, from the magnetic material may comprise iron (Fe), manganese (Mn), cobalt (Co), nickel (Ni), niobium (Nb), yttrium (Y), lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), boron (B), silicon (Si), germanium (Ge), gallium (Ga), arsenic (As), antimony (Sb), tellurium (Te), phosphorus (P), arsenic (As), antimony (Sb), bismuth (Bi), an alloy thereof, an oxide thereof, a nitride thereof, or a combination thereof.

The magnetic material 10 may include, for example, gadolinium (Gd), gadolinium (Gd)-silicon (Si)-germanium (Ge), manganese (Mn)-arsenic (As), manganese (Mn)-iron (Fe)-phosphorus (P)-arsenic (As), manganese (Mn)-iron (Fe)-phosphorus (P)-arsenic (As)-boron (B), manganese (Mn)-iron (Fe)-phosphorus (P)-germanium (Ge), manganese (Mn)-iron (Fe)-phosphorus (P)-silicon (Si), manganese (Mn)-cobalt (Co)-silicon (Si), manganese (Mn)-cobalt (Co)-Germanium (Ge), lanthanum (La)-iron (Fe)-silicon (Si), nickel (Ni)-manganese (Mn)-gallium (Ga), lanthanum (La)-manganese (Mn)-oxygen (O), neodymium (Nd)-iron (Fe)-boron (B), neodymium (Nd)-dysprosium (Dy)-iron (Fe)-boron (B), samarium Sm-cobalt (Co), samarium (Sm)-iron (Fe)-nitrogen (N), ferrite, an Alnico alloy, or the like, or a combination thereof, but is not limited thereto.

The magnetic material 10 may be in the form of a particle, and the particle may be, for example, microcrystalline.

The magnetic material 10 may have a particle diameter (e.g., an average largest particle diameter) of about 1 nanometer (nm) to about 100 micrometers (μm). The magnetic material 10 having a particle diameter within this range may prevent or suppress generation of a crack due to magnetic hysteresis and/or thermal hysteresis, and thus may provide improved magnetic cooling efficiency and life-span characteristics. Specifically, the magnetic material 10 may have a particle diameter of about 10 nm to about 5 μm, more specifically about 100 nm to about 5 μm.

The magnetic material 10 may include a plurality of materials, each having a different particle diameter. Herein, the particle diameters may each independently have a deviation of less than or equal to about 3 micrometers (μm), specifically about 5 nm to about 3 μm. The magnetic material 10 having a particle diameter deviation within this range may prevent or suppress generation of a crack due to magnetic hysteresis and thermal hysteresis, and thus may provide improved magnetic cooling efficiency and life-span characteristics. The magnetic material 10 may have a particle diameter deviation of about 20 nm to about 2 μm, and specifically, about 100 nm to about 1 μm.

The binder 20 may include a metallic glass, a glass frit, or a combination thereof.

The metallic glass may include an alloy having a disordered atomic structure including a metal, a semi-metal, or a combination thereof. The metallic glass may be an amorphous metal. The metallic glass may include an amorphous portion formed by rapidly solidifying a plurality of metals and/or semi-metals. Herein, the amorphous portion may be included in an amount of about 50 volume percent (vol %) to about 100 vol %, based on a total volume of the metallic glass, specifically, about 70 vol % to about 100 vol %, based on the total volume of the metallic glass, or more specifically, about 90 vol % to about 100 vol %, based on the total volume of the metallic glass.

The metallic glass may be amorphous when it has been in a liquid phase, which can be room temperature. Accordingly, the metallic glass can have a different structure than the crystalline structure of an alloy having a regular atomic arrangement, and can also have a structure which is different from the structure of a liquid metal which is a liquid at room temperature.

The metallic glass may include an alloy of a transition element, a noble metal, a rare earth element metal, an alkaline-earth metal, a semi-metal, or a combination thereof, for example, the metallic glass may comprise an alloy including copper (Cu), titanium (Ti), nickel (Ni), zirconium (Zr), iron (Fe), magnesium (Mg), calcium (Ca), cobalt (Co), palladium (Pd), platinum (Pt), gold (Au), cerium (Ce), lanthanum (La), yttrium (Y), gadolinium (Gd), beryllium (Be), tantalum (Ta), gallium (Ga), aluminum (Al), hafnium (Hf), niobium (Nb), strontium (Sr), ytterbium (Yb), lead (Pb), platinum (Pt), silver (Ag), phosphorus (P), boron (B), silicon (Si), carbon (C), tin (Sn), zinc (Zn), lithium (Li), molybdenum (Mo), tungsten (W), manganese (Mn), erbium (Er), chromium (Cr), praseodymium (Pr), thulium (Tm), or a combination thereof.

The metallic glass may, for example, comprise an aluminum-based metallic glass, copper-based metallic glass, titanium-based metallic glass, nickel-based metallic glass, zirconium-based metallic glass, iron-based metallic glass, cerium-based metallic glass, strontium-based metallic glass, gold-based metallic glass, ytterbium-based metallic glass, zinc-based metallic glass, calcium-based metallic glass, magnesium-based metallic glass, or a platinum-based metallic glass, but is not limited thereto.

The aluminum-based metallic glass, copper-based metallic glass, titanium-based metallic glass, nickel-based metallic glass, zirconium-based metallic glass, iron-based metallic glass, cerium-based metallic glass, strontium-based metallic glass, gold-based metallic glass, ytterbium-based metallic glass, zinc-based metallic glass, calcium-based metallic glass, magnesium-based metallic glass, and platinum-based metallic glass may each independently be an alloy including aluminum, copper, titanium, nickel, zirconium, iron, cerium, strontium, gold, ytterbium, zinc, calcium, magnesium, or platinum as a primary component, respectively, and may further include nickel (Ni), yttrium (Y), cobalt (Co), lanthanum (La), zirconium (Zr), iron (Fe), titanium (Ti), calcium (Ca), beryllium (Be), magnesium (Mg), sodium (Na), molybdenum (Mo), tungsten (W), tin (Sn), zinc (Zn), potassium (K), lithium (Li), phosphorus (P), palladium (Pd), platinum (Pt), rubidium (Rb), chromium (Cr), strontium (Sr), cerium (Ce), praseodymium (Pr), promethium (Pm), samarium (Sm), lutetium (Lu), neodymium (Nd), niobium (Nb), gadolinium (Gd), terbium (Tb), dysprosium (Dy), holmium (Ho), erbium (Er), thulium (Tm), thorium (Th), scandium (Sc), barium (Ba), ytterbium (Yb), europium (Eu), hafnium (Hf), arsenic (As), plutonium (Pu), gallium (Ga), germanium (Ge), antimony (Sb), silicon (Si), cadmium (Cd), indium (In), platinum (Pt), manganese (Mn), niobium (Nb), osmium (Os), vanadium (V), aluminum (Al), copper (Cu), silver (Ag), mercury (Hg), or a combination thereof. Herein, the primary component had the highest mole ratio among the components of the metallic glass.

Examples of the metallic glass are described in Tables 1 to 4, wherein Tg is the glass transition temperature and Tx is the crystallization temperature.

TABLE 1

| Composition | Tg (° C.) | Tx (° C.) | Composition | Tg (° C.) | Tx (° C.) |
|---|---|---|---|---|---|
| Ce70Al10Cu20 | 68 | 128 | Yb64Zn20Mg15Cu1 | 84 | 129 |
| Ce68Al10Cu20Nb2 | 68 | 149 | Au49Cu26.9Ag5.5Pd2.3Si16.3 | 128 | 186 |
| Sr60Mg18Zn22 | 58 | 101 | Yb70Zn20Mg10 | 74 | 113 |
| Sr60Li11Mg9Zn20 | 26 | 50 | Yb62.5Zn20Mg17.5 | 94 | 125 |
| Sr60Li5Mg15Zn20 | 42 | 63 | Yb64Zn20Mg15Cu1 | 84 | 129 |
| Sr60Mg20Zn15Cu5 | 62 | 101 | Yb65Zn20Mg10Cu5 | 111 | 146 |
| Sr40Yb20Mg20Zn15Cu5 | 63 | 105 | Yb62.5Zn15Mg17.5Cu5 | 108 | 128 |
| Au50Cu33Si17 | 110 | 132 | Zn40Mg11Ca31Yb18 | 123 | 148 |
| Au50Cu25.5Ag7.5Si17 | 104 | 146 | Zn40Mg11Ca35Yb14 | 120 | 147 |
| Au60Cu15.5Ag7.5Si17 | 86 | 130 | Ca65Mg15Zn20 | 102 | 137 |
| Au65Cu10.5Ag7.5Si17 | 69 | 119 | Ca65Li9.96Mg8.54Zn16.5 | 44 | 66 |
| Au70Cu5.5Ag7.5Si17 | 66 | 102 | Mg65Cu25Y10 | 155 | 219 |
| Ca65Li9.96Mg8.54Zn16.5 | 44 | 66 | Pt57.5Cu14.7Ni5.3P22.5 | 236 | 325 |
| Ce70Cu20Al10 | 68 | 135 | | | |

TABLE 2

| Composition | Tg (° C.) | Tx (° C.) |
|---|---|---|
| Al86Ni6Y4.5Co2La1.5 | 232 | 240 |
| Al86Ni7Y5Co1La1 | 227 | 233 |
| Al86Ni7Y4.5Co1La1.5 | 231 | 246 |
| Al87.5Y7Fe5Ti0.5 | 275 | 310 |
| Al87Y7Fe5Ti1 | 270 | 340 |
| Al86Y7Fe5Ti2 | 280 | 350 |
| Al88Y7Fe5 | 258 | 280 |
| Al85Y8Ni5Co2 | 267 | 297 |
| Al84La6Ni10 | 273 | 289 |
| Al86La5Ni9 | 234 | 249 |
| Al86La6Ni8 | 245 | 259 |
| Al85La6Ni9 | 256 | 272 |
| Al85La5Ni10 | 243 | 260 |
| Al84La5Ni11 | 265 | 282 |
| Al84La6Ni10 | 273 | 289 |
| Al84.5Ni5.5Y10 | 207 | 244 |
| Al85Y8Ni5Co2 | 271 | 300 |
| Al86.5Co4.5Y9 | 270 | 290 |
| Al86Y4.5Ni8La1.5 | 234 | 245 |
| (Al86Ni9La5)98Zr2 | 259 | 272 |

TABLE 3

| Composition | Tg (° C.) | Tx (° C.) |
|---|---|---|
| Ca65Mg15Zn20 | 106 | 139 |
| Mg65Cu15Ag10Gd10 | 143 | 186 |
| Mg65Cu15Ag10Gd10 | 143 | 166 |
| Mg65Cu25Gd10 | 150 | 211 |
| Mg65Cu20Ag5Y10 | 152 | 204 |
| Mg65Cu25Y10 | 153 | 215 |
| Mg65Cu15Ag10Y10 | 155 | 196 |
| Mg65Cu15Ag5Pd5Gd10 | 157 | 199 |
| Mg65Cu7.5Ni7.5Ag5Zn5Y10 | 157 | 186 |
| Mg80Ni10Gd10 | 158 | 178 |
| Ca60Mg25Ni15 | 158 | 160 |
| Mg65Cu7.5Ni7.5Ag5Zn5Gd10 | 167 | 204 |
| Mg75Ni15Gd10 | 190 | 231 |
| Mg65Ag25Gd10 | 202 | 202 |
| Mg70Ni10Gd20 | 215 | 237 |
| Cu46Gd47Al7 | 245 | 266 |
| Cu46Y42.5Al7 | 290 | 319 |
| Ti55Zr18Be14Cu7Ni6 | 312 | 349 |
| Ti51Y4Zr18Be14Cu7Ni6 | 312 | 339 |
| Ti40Zr28Cu9Ni7Be16 | 337 | 357 |
| Ti40Zr25Ni8Cu9Be18 | 348 | 395 |
| Ti49Nb6Zr18Be14Cu7Ni6 | 348 | 375 |
| Ti50Zr15Be18Cu9Ni8 | 349 | 389 |
| Ti34Zr31Cu10Ni8Be17 | 352 | 378 |
| Zr36Ti24Be40 | 354 | 440 |
| Ti65Be18Cu9Ni8 | 362 | 397 |
| Zr65Al7.5Cu17.5Ni10 | 380 | 443 |
| Zr65Al7.5Cu12.6Ni10Ag5 | 386 | 436 |
| Cu50Zr40Ti10 | 387 | 435 |
| Cu30Ag30Zr30Ti10 | 393 | 427 |
| Cu50Zr50 | 402 | 451 |
| Ti45Ni15Cu25Sn3Be7Zr5 | 407 | 468 |
| Ti50Ni15Cu32Sn3 | 413 | 466 |
| Ti50Ni15Cu25Sn3Be7 | 415 | 460 |
| Ni55Zr12Al11Y22 | 423 | 460 |
| Cu40Ni5Ag15Zr30Ti10 | 424 | 454 |

TABLE 4

| Composition | Tg (° C.) | Tx (° C.) |
|---|---|---|
| Cu47.5Zr40Be12.5 | 425 | 483 |
| Cu50Zr35Ti10Al5 | 427 | 466 |
| Cu47Ti33Zr9Y2Ni8Si1 | 429 | 456 |
| Cu47Ti33Zr11In8Si1 | 430 | 460 |
| Cu46Zr46Al8 | 430 | 513 |
| Cu50Zr45Al5 | 434 | 494 |
| Cu47Ti33Zr11Ni6Sn2Si1 | 436 | 489 |
| Cu47Ti33Nb11Ni8Si1 | 437 | 459 |
| Cu47Ti33Zr11Ni6Ag2Si1 | 441 | 465 |
| Cu46Zr47Al7 | 445 | 504 |
| Cu47Ti33Zr11Ni6Co2Si1 | 447 | 491 |
| Cu47Ti33Zr11Ni8Si1 | 447 | 484 |
| Ni20Nb20P20 | 448 | 462 |
| Cu43Zr43Al7Ag7 | 449 | 521 |
| Cu60Zr30Ti10 | 451 | 473 |
| Cu60Zr40 | 453 | 503 |
| Cu40Ni20Zr30Ti10 | 454 | 476 |
| Cu47Ti33Zr9Nb2Ni8Si1 | 455 | 489 |
| Cu57Zr28.5Ti9.5Ta5 | 456 | 478 |
| Cu50Zr43Al7 | 458 | 519 |
| Fe67Mn13B17Y3 | 506 | 555 |
| Cu46Hi42.5Al7 | 519 | 551 |
| Fe77Nb6B17 | 524 | 541 |
| Ni59Zr20Ti16Si2Sn3 | 548 | 604 |
| Fe70Mo13B17 | 549 | 577 |
| Ni57.5Zr35Al7.5 | 550 | 575 |
| Fe74Nb6B20 | 550 | 574 |
| Fe74Nb6Y3B17 | 556 | 606 |
| Fe65Mn13B17Y3 | 561 | 611 |
| Ni55Zr34Al11 | 562 | 580 |
| Ni59Zr11Ti16Si2Sn3Nb9 | 569 | 609 |
| Fe72Nb4B20Si4 | 569 | 607 |
| Ni60Nb15Zr25 | 570 | 601 |
| Ni61Zr28Nb7Al4 | 575 | 625 |
| Ni57.5Zr24Nb11Al7.5 | 576 | 609 |
| Fe57Mo13B17Y3 | 587 | 628 |
| Ni61Zr20Nb7Al4Ta8 | 603 | 661 |
| (Fe72Nb4B20Si4)96Y4 | 632 | 660 |
| Ni60Nb30Ta10 | 661 | 686 |

The glass frit may comprise a ceramic composition, for example, a PbO—SiO₂-based, PbO—SiO₂—B₂O₃-based, PbO—SiO₂—B₂O₃—ZnO-based, PbO—SiO₂—B₂O₃—BaO-based, PbO—SiO₂—ZnO—BaO-based, ZnO—SiO₂-based, ZnO—B₂O₃—SiO₂-based, ZnO—K₂O—B₂O₃—SiO₂—BaO-based, Bi₂O₃—SiO₂-based, Bi₂O₃—B₂O₃—SiO₂-based, Bi₂O₃—B₂O₃—SiO₂—BaO-based, ZnO—BaO—B₂O₃—P₂O₅—Na₂O-based, or Bi₂O₃—B₂O₃—SiO₂—BaO—ZnO-based glass frit, or a combination thereof, but is not limited thereto.

The metallic glass and/or the glass frit may be softened at a temperature greater than or equal to a glass transition temperature (Tg) thereof and may provide a liquid-like behavior. This liquid-like behavior may be maintained between the glass transition temperature (Tg) and crystallization temperature (Tx), to provide a supercooled liquid region (ΔTx).

The metallic glass and the glass frit may, for example, have a glass transition temperature (Tg) of less than or equal to about 800° C., specifically, about 50° C. to about 800° C. More specifically, the metallic glass and the glass frit may have a glass transition temperature (Tg) of about 50 to about 600° C. The metallic glass and the glass frit may have a supercooled liquid region (ΔTx) ranging from about 1 Kelvin (K) to about 200 K, specifically about 10 K to about 150 K.

The binder 20 may be contacted with, e.g., mixed with, the magnetic material 10 to form a mixture. When the mixture is heat-treated at a temperature of greater than or equal to the glass transition temperature (Tg) of the binder 20, the binder 20 melts and may viscously flow, may have liquid-like behavior, and may wet the magnetic material 10. Accordingly and while not wanting to be bound by theory, it is understood that when the binder 20 viscously flows, it can fill in the space among the particles of the magnetic material 10 and may improve adherence of the particles of the magnetic material 10, and may decrease friction among the particles of the magnetic material 10 to provide close-packing of the particles of the magnetic material 10. In addition, the binder 20 may improve the thermal conductivity of the magnetic material 10, for example by improving thermal conductivity between particles of the magnetic material 10, and thus can improve magnetocaloric effects.

Furthermore, the binder 20 has viscous flow properties within a selected temperature range, and thus the binder may be used to provide a desired shape. For example, the mixture may be disposed into a mold having a selected shape, and the mold may be heat-treated and separated from the molded mixture, resulting in a product having the selected shape.

In addition, the binder 20 may fill in spaces among the particles of the magnetic material 10 to form a magnetic composite 100, reducing brittleness of the magnetic material 10 and providing improved mechanical strength to the magnetic composite 100.

Furthermore, the heat treatment may be performed at a relatively low temperature, e.g., a temperature below the melting point of the magnetic material 10, and may be performed in air. In an embodiment, the heat treatment does not substantially affect the magnetic properties of the magnetic material 10.

The binder 20 may be included in an amount of about 0.01 weight percent (wt %) to about 50 wt %, specifically about 0.1 wt % to about 40 wt %, more specifically about 1 wt % to about 30 wt %, based on the total weight of the magnetic composite 100. When the amount of binder 20 is within this range, the binder 20 may stabilize the magnetic properties of the magnetic composite.

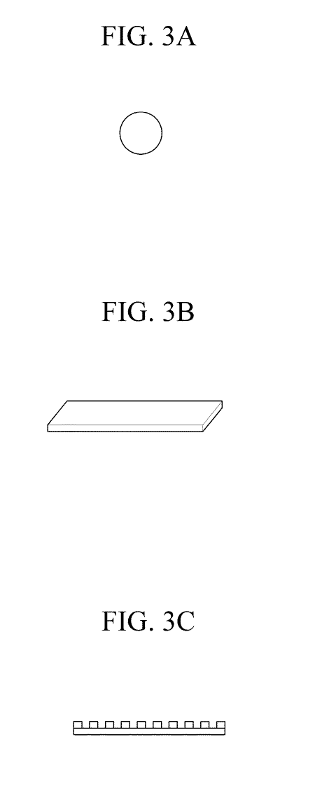

FIG. 2 is a schematic view showing another embodiment of the magnetic composite.

Referring to FIG. 2, a magnetic composite 110 according to another embodiment includes two or more of a first, second, and third magnetic materials 10a, 10b, and 10c, respectively, each having a different Curie temperature, and a binder 20 including the metallic glass, glass frit, or the combination thereof.

The first, second, and third magnetic materials 10a, 10b, and 10c each have an intrinsic temperature range in which magnetic properties are present, and lose the magnetic properties at a temperature greater than or equal to the Curie temperature. The temperature range of the magnetic properties may be expanded by including two or more of the first, second, and third magnetic materials 10a, 10b, and 10c, each of which has a different Curie temperature, to expand the operational temperature range. Furthermore, the aforementioned heat treatment temperature may be lower than the melting temperature of the first, second, and third magnetic materials 10a, 10b, and 10c, and thus may have no substantial influence on the desirable properties of the first, second, or third magnetic materials 10a, 10b, and 10c.

The magnetic composite may be processed to have various shapes and may be fabricated into an article. The article may, for example, be a heat exchanger, but is not limited thereto.

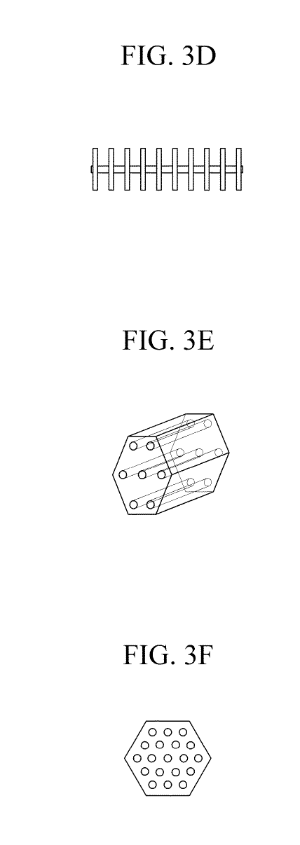

FIGS. 3A to 3F are schematic views showing various shapes of an embodiment of an article including the magnetic composite.

Referring to FIGS. 3A to 3F, the article may be processed to have various shapes, for example, a spherical shape (FIG. 3A), a plate shape (FIG. 3B), microchannel structure (FIG. 3C), a micro-fin structure (FIG. 3D), or a honey-comb structure (FIGS. 3E and 3F), without limitation.

Hereinafter, an embodiment of a method of manufacturing the magnetic composite is further described.

A method of manufacturing the magnetic composite according to an embodiment includes contacting, e.g., mixing, a magnetic material with a binder comprising a metallic glass, a glass frit, or a combination thereof to form a mixture; and heat-treating the mixture at greater than or equal to a glass transition temperature of the binder to manufacture the magnetic composite.

The magnetic material may comprise particles. The particle type magnetic material may be prepared by, for example, uniformly mixing a precursor of a metal, a semi-metal, an alloy thereof, an oxide thereof, or a combination thereof with a reducing agent, and then heat-treating the mixture.

The precursor may be a precursor of the metal, semi-metal, alloy thereof, oxide thereof, or a combination thereof described above, for example, and may comprise iron (Fe), manganese (Mn), cobalt (Co), nickel (Ni), niobium (Nb), yttrium (Y), lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), boron (B), silicon (Si), germanium (Ge), gallium (Ga), arsenic (As), antimony (Sb), tellurium (Te), phosphorus (P), arsenic (As), antimony (Sb), bismuth (Bi), or a combination thereof.

The reducing agent may include, for example, a Group I element, a Group II element, a Group III element, or a combination thereof. The Group I element may include, for example, lithium (Li), sodium (Na), potassium (K), or a combination thereof; the Group II element may include, for example, beryllium (Be), magnesium (Mg), calcium (Ca), strontium (Sr), radium (Ra), or a combination thereof; and the Group III element may include, for example, aluminum (Al).

The reducing agent may be uniformly dispersed in the mixture. While not wanting to be bound by theory, it is understood that because the oxidation of the reducing agent is an exothermic reaction, the reducing agent may uniformly heat the mixture and promote a uniform reaction among the materials included in the mixture. In addition, the reducing agent is oxidized into an oxide among the magnetic materials. The oxide is understood to not substantially react with the magnetic material. Accordingly, the oxide may control growth of the magnetic material and thus may control a particle size and uniformity of the magnetic material.

The mixing of the reducing agent with the precursor may be performed, for example, in a ball mill process, an attrition mill process, a jet mill process, a spike mill process, or a combination thereof, to provide mixture having suitable uniformity, but is not limited thereto.

The mixing of the precursor with the reducing agent may be performed under an inert atmosphere such as argon gas or the like, under a reducing atmosphere such as hydrogen gas or the like, in a vacuum, or under in an ambient atmosphere including oxygen gas.

The heat treatment of the mixture may be performed using, for example, convection heating, a microwave, induction heating, spark plasma sintering, or the like. The heat treatment may be performed at a temperature which is lower than the melting point of the magnetic material, for example, at a temperature ranging of about 500° C. to about 1,200° C., specifically about 550° C. to about 1,100° C. The heat treatment within this range may efficiently promote reaction of the precursors and may be effective to form magnetic material particles.

The reducing agent is oxidized by the heat treatment to form an oxide, and the precursor is reduced to form magnetic material particles which are magnetic and may provide a magnetocaloric effect.

The magnetic material particles are mixed with a binder including the metallic glass, the glass frit, or the combination thereof. The mixing may be performed, for example, in a ball mill process, in an attrition mill process, in a jet mill process, in a spike mill process, or a combination thereof, but is not limited thereto.

Next, the mixture of a magnetic material and a binder is heat-treated and optionally shaped to provide a desirable shape.

The heat-treating of the mixture of a magnetic material and the binder may comprise a heat treatment at a temperature which is greater than or equal to a glass transition temperature (Tg) of the binder. For example, the heat treatment may be performed at a temperature of less than or equal to about 800° C. and specifically, about 50° C. to about 800° C., specifically about 100° C. to about 700° C.

The heat treatment within the foregoing temperature range may make the binder, which includes the metallic glass, the glass frit, or the combination thereof, provide a suitable liquid-like behavior such that it is effective to viscously flow among the magnetic materials as aforementioned. Accordingly, the heat-treated mixture may be shaped to have a selected shape using a mold with the selected shape.

The method may further comprise shaping the mixture, and the shaping may be performed using a method of, for example, hot press formation, hot extrusion formation, hot rolling formation, or spark plasma sintering, without limitation.

The temperature range for the heat treatment may be lower than the melting temperature of the magnetic material and may not significantly influence the desirable properties of the magnetic material. In addition, the magnetic composite may be processed to have a desired shape without firing the magnetic material itself, and thus may be easily fabricated to have a desired shape, e.g., a shape with a large surface area, such as a microchannel or a micro-fin.

Accordingly, the aforementioned magnetic composite may be used to fabricate an article having a large surface area in order to increase heat exchange efficiency and have a desired shape, such as a spherical shape, a plate-like shape, a microchannel structure, a micro-fin structure, or a honey-comb structure, but is not limited thereto.

The article may be, for example, a heat exchanger, a magnetic cooling device, a magnetocaloric generator, a magnetocaloric pump, or the like.

The following examples illustrate this disclosure in more detail. However, it is understood that this disclosure shall not limited by these examples.

### Preparation of Magnetic Material

### Preparation Example 1

MnCl₂, As₂O₃, and Mg in a mole ratio of 1:0.5:2.5 are mixed with a ball mill for about 5 hours in a dried air (no moisture), obtaining a mixture. The mixture is filled in a metal mold and pressed with a pressure of about 300 kilograms-force per square centimeter (kgf/cm²) to form a 1 centimeter (cm)×1 cm (diameter×height) cylindrical shape. The formed mixture is put in an alumina crucible, and the alumina crucible is put in a quartz tube. The quartz tube is sealed under vacuum and heat-treated at 600° C. for 5 hours and then slowly cooled down. Then, the heat-treated mixture is ground and then added to a 0.1 molar (M) hydrochloric acid aqueous solution. The resulting mixture is stirred for one hour to obtain a manganese (Mn)-arsenic (As) magnetic material.

### Preparation Example 2

MnCl₂, Fe₂O₃, P, As₂O₃, and Mg in a mole ratio of 1:0.5:0.5:0.25 are mixed with a ball mill for 5 hours in dried air (no moisture). The mixture is placed into a metal mold and pressed with a pressure of 300 kgf/cm² to form a 1 cm×1 cm (diameter×height) cylindrical shape. The pressed mixture is put in an alumina crucible, and the alumina crucible is put in a quartz tube. The quartz tube is sealed under vacuum and heat-treated at 800° C. for 5 hours and then is slowly cooled down. Then, the heat-treated mixture is ground, and then added to a 0.1 M hydrochloric acid aqueous solution. The resulting mixture is stirred for one hour to obtain a manganese (Mn)-iron (Fe)-phosphorus (P)-arsenic (As) magnetic material (with a Curie temperature of 300 K).

### Preparation Example 3

MnCl₂, Fe₂O₃, P, As₂O₃, B₂O₃, and Mg in a mole ratio of 1:0.5:0.5:0.25:0.01:3.28 are mixed with a ball mill for 5 hours in dried air (no moisture). The mixture is placed into a metal mold and pressed with a pressure of 300 kgf/cm² to form a 1 cm×1 cm (diameter×height) cylindrical shape. The pressed mixture is put in an alumina crucible, and the alumina crucible is put in a quartz tube. The quartz tube is sealed under vacuum, heat-treated at 800° C. for 5 hours, and slowly cooled down. This heat-treated mixture is ground and added to a 0.1 M hydrochloric acid aqueous solution. The resulting mixture is stirred for one hour to obtain a manganese (Mn)-iron (Fe)-phosphorus (P)-arsenic (As)-boron (B) magnetic material (with a Curie temperature of 310 K).

### Preparation of Magnetic Composite

### Example 1

95 wt % of the manganese (Mn)-arsenic (As) magnetic material according to Preparation Example 1 and 5 wt % of Al₈₅Ni₅Co₂Y₈ metallic glass are mixed with a ball mill. The mixture is hot-pressed at 500° C. for 1 minute to 10 minutes to obtain a magnetic composite.

### Example 2

The manganese (Mn)-iron (Fe)-phosphorus (P)-arsenic (As) magnetic material according to Preparation Example 2, the manganese (Mn)-iron (Fe)-phosphorus (P)-arsenic (As)-boron (B) magnetic material according to Preparation Example 3, and AI₈₅Ni₅Co₂Y₈ metallic glass are mixed in a weight ratio of 45:45:10. Then, the mixture is hot-pressed at 600° C. for 1 minute to 10 minutes to obtain a magnetic composite.

### Comparative Example 1

The manganese (Mn)-arsenic (As) magnetic material according to Preparation Example 1 is used.

### Comparative Example 2

The manganese (Mn)-iron (Fe)-phosphorus (P)-arsenic (As) magnetic material according to Preparation Example 2 and the manganese (Mn)-iron (Fe)-phosphorus (P)-arsenic (As)-boron (B) magnetic material according to Preparation Example 3 are mixed in a weight ratio of 50:50. Then, the mixture is hot-pressed at 600° C., forming magnetic composite material.

### Evaluation 1

The magnetic composite according to Example 1 is examined regarding its cross-section using a scanning electron microscope (SEM).

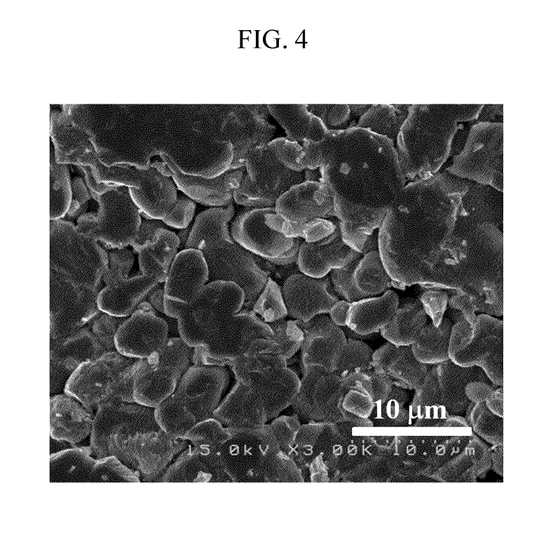

FIG. 4 is a scanning electron microscope (SEM) photograph showing the cross-section of the magnetic composite according to Example 1.

Referring to FIG. 4, the magnetic composite maintains the particle shape of the manganese (Mn)-arsenic (As) magnetic material with metallic glass filled among the particles.

### Evaluation 2

The magnetic composite according to Example 1 and the magnetic material according to Comparative Example 1 are compared regarding their magnetic entropy change value.

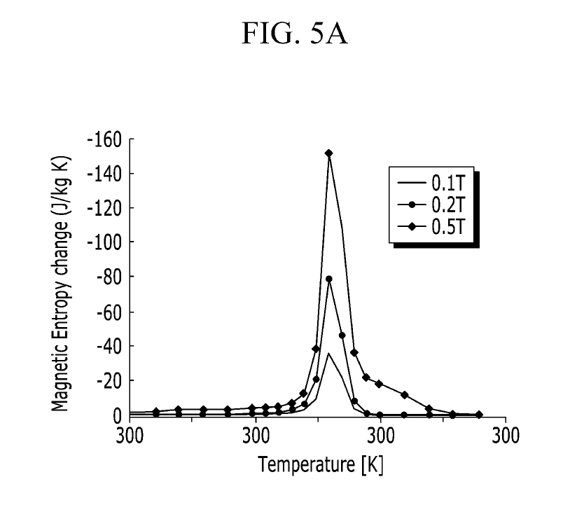

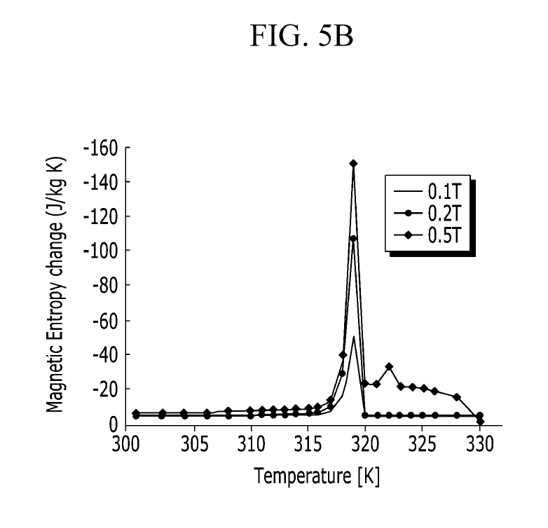

FIG. 5A is a graph of magnetic entropy change (Joules per kilogram per Kelvin, J/kg·K) versus temperature (Kelvin, K) of the magnetic material according to Comparative Example 1, and FIG. 5B is a graph of magnetic entropy change (Joules per kilogram per Kelvin, J/kg·K) versus temperature (Kelvin, K) of the magnetic composite according to Example 1.

Referring to FIGS. 5A and 5B, the magnetic composite according to Example 1 substantially maintains the magnetic entropy characteristics compared with the magnetic material according to Comparative Example 1.

### Evaluation 3

The magnetic composite according to Example 2 and the magnetic material according to Comparative Example 2 are compared regarding their magnetic entropy change.

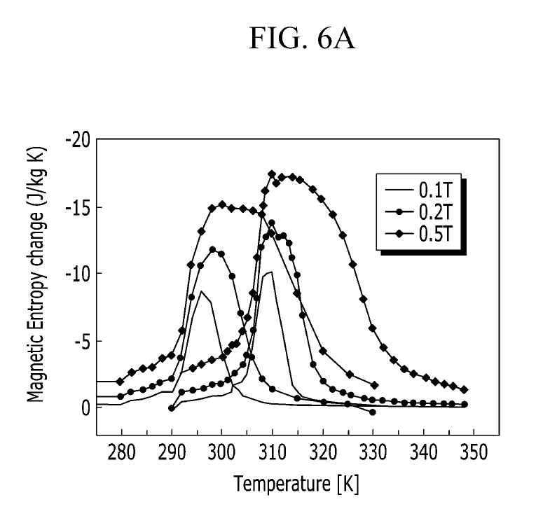

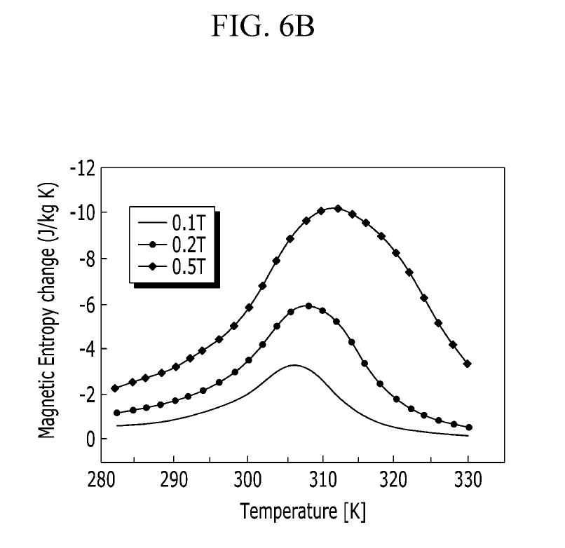

FIG. 6A is a graph showing the magnetic entropy change (Joules per kilogram per Kelvin, J/kg·K) versus temperature (Kelvin, K) of the magnetic material according to Comparative Example 2, and FIG. 6B is a graph showing the magnetic entropy change (Joules per kilogram per Kelvin, J/kg·K) versus temperature (Kelvin, K) of the magnetic composite according to Example 2.

Referring to FIGS. 6A and 6B, the magnetic composite according to Example 2 substantially maintains the magnetic entropy characteristics of each magnetic material compared with the magnetic material according to Comparative Example 2. In particular, the magnetic composite according to Example 2 has an enlarged temperature range with a magnetic entropy change.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A magnetic composite comprising:
a magnetic material; and
a binder including a metallic glass, a glass frit, or a combination thereof.

2. The magnetic composite of claim 1, wherein the magnetic material comprises a magnetocaloric material, a soft magnetic material, a hard magnetic material, or a combination thereof.

3. The magnetic composite of claim 2, wherein the magnetic material comprises a metal, a semi-metal, an alloy thereof, an oxide thereof, or a combination thereof.

4. The magnetic composite of claim 3, wherein the magnetic material comprises iron, manganese, cobalt, nickel, niobium, yttrium, lanthanum, cerium, praseodymium, neodymium, promethium, samarium, europium, gadolinium, terbium, dysprosium, holmium, erbium, thulium, ytterbium, boron, silicon, germanium, gallium, arsenic, antimony, tellurium, phosphorus, arsenic, antimony, bismuth, an alloy thereof, an oxide thereof, a nitride thereof, or a combination thereof.

5. The magnetic composite of claim 1, wherein the magnetic material is in the form of a particle.

6. The magnetic composite of claim 5, wherein the magnetic material has a particle diameter of about 1 nanometer to about 100 micrometers.

7. The magnetic composite of claim 1, wherein the binder has a glass transition temperature of about 50° C. to about 800° C.

8. The magnetic composite of claim 1, wherein the binder has a supercooled liquid region of about 1 K to about 200 K.

9. The magnetic composite of claim 1, wherein the metallic glass is an alloy including copper, titanium, nickel, zirconium, iron, magnesium, calcium, cobalt, palladium, platinum, gold, cerium, lanthanum, yttrium, gadolinium, beryllium, tantalum, gallium, aluminum, hafnium, niobium, strontium, ytterbium, lead, platinum, silver, phosphorus, boron, silicon, carbon, tin, zinc, lithium, molybdenum, tungsten, manganese, erbium, chromium, praseodymium, thulium, or a combination thereof.

10. The magnetic composite of claim 1, wherein the binder encapsulates at least a portion of the magnetic material.

11. The magnetic composite of claim 1, wherein the binder is included in an amount of about 0.01 weight percent to about 50 weight percent, based on a total weight of the magnetic composite.

12. The magnetic composite of claim 1, wherein the magnetic material comprises a first magnetic material and a second magnetic material, each of which has a different Curie temperature.

13. A method of manufacturing a magnetic composite, the method comprising
contacting a magnetic material with a binder comprising a metallic glass, a glass frit, or a combination thereof to form a mixture; and
heat-treating the mixture at a temperature greater than or equal to a glass transition temperature of the binder to manufacture the magnetic composite.

14. The method of claim 13, wherein the heat-treating of the mixture is at a temperature which is lower than a melting temperature of the magnetic material.

15. The method of claim 13, wherein the heat-treating of the mixture is at about 50° C. to about 800° C.

16. The method of claim 13, wherein the method further comprises shaping the mixture, and wherein the shaping comprises hot press formation, hot extrusion formation, hot rolling formation, spark plasma sintering, or a combination thereof.

17. An article comprising the magnetic composite according to claim 1.

18. The article of claim 17, wherein the article has a spherical shape, a plate shape, a microchannel structure, a micro-fin structure, a honey-comb structure, or a combination thereof.

19. A device comprising the article according to claim 17.

20. The device of claim 19, wherein the device is a magnetic cooling device, a magnetocaloric generator, or a magnetocaloric pump.
